(19) United States
(12) Patent Application Publication
(10) Pub. No.: US 2003/0160201 A1
(43) Pub. Date: Aug. 28, 2003

(54) High-pressure tank

(76) Inventors: Tatsuyuki Sugiura, Ohbu-shi (JP); Shoichi Hagiwara, Ohbu-shi (JP); Kiyoshi Yoshizumi, Toyota-shi (JP)

Correspondence Address: STEVENS, DAVIS, MILLER & MOSHER, L.L.P., Suite 850, 1615 L Street, N.W., Washington, DC, 20036, US

(21) Appl. No.: 10/359,173

(22) Filed: Feb. 6, 2003

(30) Foreign Application Priority Data
Feb. 22, 2002 (JP) 2002-046236

(51) Int. Cl. F16K 51/00

(52) U.S. Cl. 251/144

(57) ABSTRACT

A high-pressure tank in which the sealing ability and pressure-proof strength at a mouth portion are prevented from being lower by a high pressure within the tank, wherein the mouth portion 2 projects into the inside of the tank, and internal threads are formed on an inner peripheral surface of the mouth portion, and a thread member is threadedly engaged with the internal threads. Further, a seal member is provided between the mouth portion and the thread portion, and is disposed adjacent to the inner peripheral surface of the mouth portion adjacent to an inner end thereof disposed within the tank. A high pressure within the tank acts on an outer peripheral surface of the mouth portion while the atmospheric pressure acts on the inner peripheral surface of the mouth portion, so that the mouth portion is compressed radially inwardly, thereby preventing the loosening of the tightened seal member.

### BACKGROUND OF THE INVENTION

1. Field of the Invention

This invention relates to a high-pressure tank, and more particularly to the structure of a mouth portion of the high-pressure tank.

2. Related Art

In a conventional pressure tank such as a fuel gas-filling pressure tank for mounting on a vehicle, a mouth portion 102 of the tank 101 is formed that a portion of a body of the tank 101 is bent to project outwardly from the body as shown in FIG. 5, and internal threads 103 are formed on an inner peripheral surface of the mouth portion 102, and external threads 105, formed on a valve device 104, are threadedly engaged with the internal threads 103, and a seal member 106 is provided between an outwardly-projecting end portion of the mouth portion 102 and the valve device 104. For example, such a fuel gas-filling pressure tank is disclosed in JP-A-8-109913 and U.S. Pat. No. 5,458,151.

In the above conventional mouth structure, a high pressure within the tank 101 acts on the inner peripheral surface of the mouth portion 102 through gaps in the threaded portions as indicated by arrows A in FIG. 5, and the mouth portion 102 is expanded because of the pressure difference between this high pressure and the atmospheric pressure acting on the outer peripheral surface of the mouth portion 102, and therefore there is a possibility that tightening to the seal member 106, mounted at the projecting end portion of the mouth portion 102, is loosened, so that the sealing ability and the pressure-proof strength are lowered, and the durability of the tank is lowered.

### SUMMARY OF THE INVENTION

It is therefore an object of this invention to provide a high-pressure tank in which the sealing ability and pressure-proof strength at a mouth portion are enhanced, thereby enhancing the durability of the tank.

According to a first aspect of the present invention, there is provided a high-pressure tank including a mouth portion having internal threads formed on an inner peripheral surface thereof, wherein the mouth portion is so provided that a pressure within the tank acts on an outer peripheral surface of the mouth portion.

According to a second aspect of the invention, there is provided a high-pressure tank including a mouth portion having internal threads formed on an inner peripheral surface thereof, wherein the mouth portion projects inside of the high-pressure tank so that a pressure within the tank acts on an outer peripheral surface of the mouth portion.

In the first and second aspects, the high pressure within the tank acts on the outer peripheral surface of the mouth portion, and therefore the durability of the mouth portion and hence the durability of the high-pressure tank are enhanced as compared with the conventional structure in which the mouth portion is pressed radially outwardly, that is, in a diameter-increasing direction.

According to a third aspect of the invention, there is provided a high-pressure tank including a mouth portion having internal threads formed on an inner peripheral surface thereof, wherein the mouth portion projects inside of the high-pressure tank so that a pressure within the tank acts on an outer peripheral surface of the mouth portion, and a seal member is provided on the inner peripheral surface of the mouth portion adjacent to an inner end of the mouth portion.

In the third aspect, the high pressure within the tank acts on the outer peripheral surface of the mouth portion, while the atmospheric pressure acts on the threaded portion formed on the inner peripheral surface of the mouth portion. Thus, because of the pressure difference between the atmospheric pressure and the pressure within the tank, the mouth portion is compressed radially inwardly, that is, in a diameter-reducing direction, so that the seal member, provided adjacent to the inner end of the mouth portion, is tightened. Therefore, the loosening of the tightened seal member is prevented, and the sealing ability and pressure-proof strength at the mouth portion are enhanced, and the durability of the tank is enhanced.

The high-pressure tank according to any one of the first to third aspects (in which the internal threads are formed on the inner peripheral surface of the mouth portion) can include an outer wall, projecting outwardly from an outer surface of the tank, and an inner wall extending from an outer end of the outer wall into the inside of the tank, and the mouth portion being defined by this inner wall.

With this construction, also, similar effects as described above can be achieved.

In the present invention, a valve device may be threadedly engaged with the internal threads of the mouth portion.

With this construction, also, similar effects as described above can be achieved.

According to a fourth aspect, there is provided a high-pressure tank including a mouth portion having internal threads formed on an inner peripheral surface thereof, wherein the mouth portion is so provided that pressures, acting respectively on inner and outer peripheral surfaces of the mouth portion, are substantially equal to each other.

In the fourth aspect, the pressures, acting respectively on the outer and inner peripheral surfaces of the mouth portion are substantially equal to each other, and thus, the mouth portion will not be deformed. Therefore, the pressure-proof strength is enhanced, and the durability of the tank is enhanced.

In the fourth aspect, there can be provided a construction in which the mouth portion projects inside of the high-pressure tank, and a seal member is provided on the inner peripheral surface of the mouth portion adjacent to an outer end of the mouth portion.

In this construction, the same pressure within the tank acts on the inner and outer peripheral surfaces of the mouth portion, projecting inside of the tank, and the pressures are balanced, so that the mouth portion will not be deformed by the pressure within the tank. Therefore, the loosening of the tightened seal member is prevented, and the sealing ability and compresive strength at the mouth portion are enhanced, and the durability of the tank is enhanced.

In the fourth aspect, there may be provided a construction in which the mouth portion projects outwardly from an outer surface of the high-pressure tank, and a seal member is provided on the inner peripheral surface of the mouth portion adjacent to an inner end of the mouth portion.

In this construction, also, the same pressure in the atmosphere acts on the inner and outer peripheral surfaces of the mouth portion, projecting outwardly from the tank, and the pressures are balanced, so that the mouth portion will not be deformed by the pressure. Therefore, the loosening of the tightened seal member is prevented, and the sealing ability and pressure-proof strength at the mouth portion are enhanced, and the durability of the tank is enhanced.

In the fourth aspect and its related construction, a valve device may be threadedly engaged with the internal threads of the mouth portion.

With this construction, also, similar effects as described above can be achieved.

### BRIEF DESCRIPTION OF THE DRAWINGS

FIG. 1 is a cross-sectional view showing a mouth structure of a first embodiment of a high-pressure tank according to the present invention.

FIG. 2 is a cross-sectional view showing a mouth structure of a second embodiment of a high-pressure tank according to the invention.

FIG. 3 is a cross-sectional view showing a mouth structure of a third embodiment of a high-pressure tank according to the invention.

FIG. 4 is a cross-sectional view showing a mouth structure of a fourth embodiment of a high-pressure tank according to the invention.

FIG. 5 is a cross-sectional view showing a conventional mouth structure in a high pressure tank.

### DESCRIPTION OF THE PREFERRED EMBODIMENTS

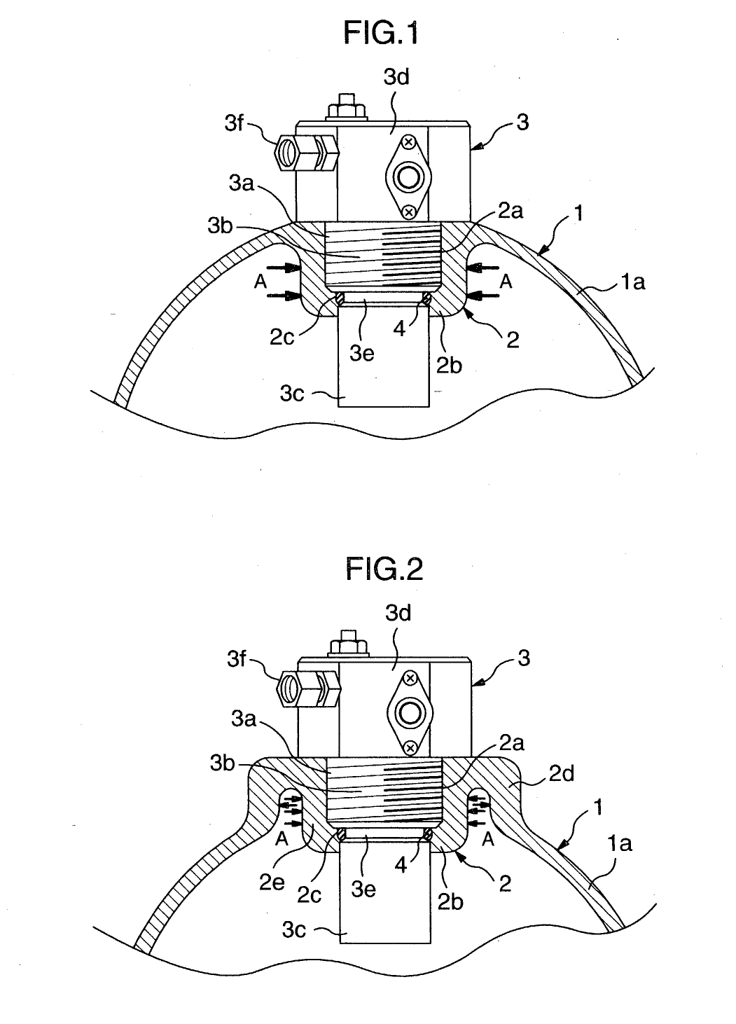

Preferred embodiments of mouth structures of high-pressure tanks according to the present invention will now be described with reference to FIGS. 1 to 4.

FIG. 1 shows the first embodiment according to the invention.

In this first embodiment, a mouth portion 2 is formed on the tank 1, and more specifically a relevant portion of a tank-forming wall la is bent into the inside of the tank 1 to form the mouth portion 2 projecting into the inside of the tank 1. The mouth portion 2 is formed into a cylindrical shape, and internal threads 2a are formed on an inner peripheral surface of this mouth portion 2. A reduced-diameter portion 2b is formed at a distal end portion of the mouth portion 2 projecting into the tank, and a sealing surface 2c is formed on an inner peripheral surface of the reduced-diameter portion 2b. Therefore, the sealing surface 2c is disposed inwardly of the internal threads 2a within the tank.

A thread member 3 is threadedly engaged with the internal threads 2a of the mouth portion 2. One example of the thread member 3 is a valve device. The valve device 3, shown in the drawings, includes a thread portion 3b, which has external threads 3a (for threaded engagement with the internal threads 2a of the mouth portion 2) formed on an outer peripheral surface thereof, and contains a shut-off valve (such as a solenoid valve or a pressure regulating valve) therein, a projection 3c, which projects further into the inside of the tank than the thread portion 3b, and has an introduction passage for introducing gas within the tank into the valve device 3, and a gas discharging portion 3d which is disposed outwardly of the thread portion 3b, and is larger in diameter than the thread portion 3b. Further, a seal member-fitting groove 3e, corresponding to the sealing surface 2c, is formed in the valve device 3 inwardly of the thread portion 3b. Therefore, a seal member 4, provided in the seal member-fitting groove 3e, is disposed adjacent to the distal end (inner end) of the mouth portion 2 within the tank.

In the above structure, the seal member 4 is fitted in the seal member-fitting groove 3e in the thread member 3 (for example, the valve device 3), and then the valve device 3 is attached to the mouth portion 2 of the tank 1 by threadedly engaging the external threads 3a with the internal threads 2a formed on the mouth portion 2, as shown in FIG. 1. As a result, the seal member 4 is held in close contact with the sealing surface 2c of the mouth portion 2, thereby preventing the gas within the tank 1 from leaking to the exterior.

The high pressure of the gas, filled in the tank 1 when in use, acts on the outer peripheral surface of the mouth portion 2, projecting into the inside of the tank 1, as indicated in arrows A in FIG. 1, and the atmospheric pressure outside the tank 1 acts on the threaded portions of the internal threads 2a and external threads 3a, and hence on the inner peripheral surface of the mouth portion 2. Therefore, because of this pressure difference, the mouth portion 2 is compressed radially inwardly (i.e., in a diameter-reducing direction), so that the seal member 4 is tightened. Therefore, the loosening of the tightened seal member 4 is prevented, and the sealing ability and pressure-proof strength at the mouth portion 2 are enhanced, and the durability of the tank is enhanced.

The gas within the tank 1 is introduced into the valve device 3 through a gas inlet port, formed in the projection 3c, and is discharged from an outlet port 3f in the gas discharging portion 3d by opening the shut-off valve (such as a solenoid valve or a pressure regulating valve) provided within the thread portion 3b.

FIG. 2 show the second embodiment according to the present invention.

This second embodiment is a modified example of the mouth structure of the first embodiment.

More specifically, a high-pressure tank 1 includes an outer wall 2d of a cylindrical shape, projecting outwardly from a tank forming-wall 1a of the tank 1, and an inner wall 2e of a cylindrical shape extending from an outer end of the outer wall 2d into the inside of the high-pressure tank 1 in concentric relation to the outer wall 2d, and thus, a mouth portion 2 is defined by the inner wall 2e. The inner wall 2e is formed by bending a relevant portion of a tank-forming wall 1a of the high-pressure tank 1.

The other structure is similar to that of the first embodiment, and therefore similar portions to those of the first embodiment will be designated by identical reference numerals, respectively, and explanation thereof will be omitted.

In this second embodiment, also, a high gas pressure within the tank 1 acts on an outer peripheral surface of the inner wall 2e, forming the mouth portion 2, as indicated by arrows A in FIG. 2, while the atmospheric pressure outside the tank 1 acts on an inner peripheral surface of the inner wall 2e, so that similar effects as described above for the first embodiment are achieved.

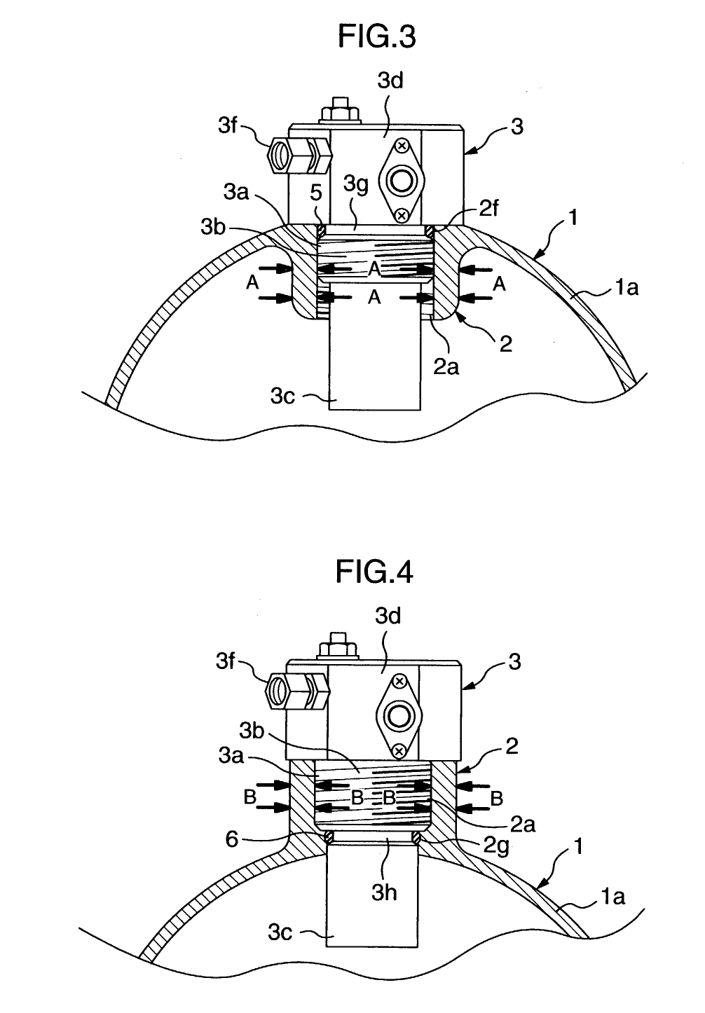

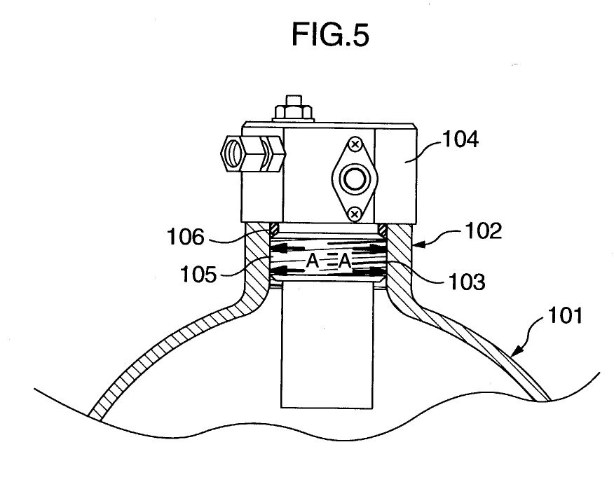

FIG. 3 shows the third embodiment according to the invention.

In this third embodiment, a mouth portion 2 is formed on a tank 1, and more specifically a relevant portion of a tank-forming wall 1a is bent into the inside of the tank 1 to form the mouth portion 2 projecting into the inside of the tank 1. The mouth portion 2 is formed into a cylindrical shape, and internal threads 2a are formed on an inner peripheral surface of this mouth portion 2. A sealing surface 2f is formed at the inner peripheral surface of the mouth portion 2 adjacent to an outer end of the internally-threaded portion 2a, that is, adjacent to the outer end of this mouth portion 2 lying on the outer surface of the tank. Therefore, the sealing surface 2f is disposed outwardly of the internal threads 2a.

A thread member 3 is threadedly engaged with the internal threads 2a of the mouth portion 2. One example of the thread member 3 is a valve device as described above for the first embodiment. The valve device 3 includes a thread portion 3b, which has external threads 3a (for threaded engagement with the internal threads 2a of the mouth portion 2) formed on an outer peripheral surface thereof, and contains a shut-off valve (such as a solenoid valve or a pressure regulating valve) therein, a projection 3c, which projects further into the inside of the tank than the thread portion 3b, and has an introduction passage for introducing gas within the tank into the valve device 3, and a gas discharging portion 3d which is disposed outwardly of the thread portion 3b, and is larger in diameter than the thread portion 3b. Further, a seal member-fitting groove 3g, corresponding to the sealing surface 2f, is formed in the valve device 3 outwardly of the thread portion 3b. Therefore, a seal member 5, provided in the seal member-fitting groove 3g, is disposed adjacent to the outer end of the mouth portion 2 in the outside of the tank 1.

In the above structure, the seal member 5 is fitted in the seal member-fitting groove 3g in the thread member 3 (for example, the valve device 3), and then the valve device 3 is attached to the mouth portion 2 of the tank 1 by threadedly engaging the external threads 3a with the internal threads 2a formed on the mouth portion 2, as shown in FIG. 3. As a result, the seal member 5 is held in close contact with the sealing surface 2f of the mouth portion 2, thereby preventing the gas within the tank 1 from leaking to the exterior.

The seal member 5 is provided adjacent to the outer end of the mouth portion 2, that is, disposed outwardly of the region where the internal threads 2a and external threads 3a are threadedly engaged with each other. With this construction, a high gas pressure within the tank acts on the outer peripheral surface and inner peripheral surface (serving as the threaded portion) of the mouth portion 2 projecting into the inside of the tank 1 as indicated by arrows A in FIG. 3. Therefore, the same pressure acts on the inner and outer peripheral surfaces of the mouth portion 2, and the pressures are balanced, so that the mouth portion 2 will not be deformed by the high pressure within the tank. Therefore, the loosening of the tightened seal member 5 is prevented, and the sealing ability and pressure-proof strength at the mouth portion 2 are enhanced, and the durability of the tank is enhanced.

In this third embodiment, also, the internal structure of the valve device 3 is similar to that of the first embodiment, and the gas within the tank 1 can be discharged by the valve device 3.

FIG. 4 shows the fourth embodiment according to the present invention.

In this fourth embodiment, a mouth portion 2 is formed on a tank 1, and more specifically a relevant portion of a tank-forming wall 1a is bent outwardly of the tank 1 to form the mouth portion 2 projecting outwardly from the tank 1. The mouth portion 2 is formed into a cylindrical shape, and internal threads 2a are formed on an inner peripheral surface of this mouth portion 2. A sealing surface 2g is formed on the inner peripheral surface of the mouth portion 2 adjacent to an inner end of the internally-threaded portion 2a, that is, at an inner end of the mouth portion 2. Therefore, the sealing surface 2g is disposed inwardly of the internal threads 2a in the tank.

A thread member 3 is threadedly engaged with the internal threads 2a of the mouth portion 2. One example of the thread member 3 is a valve device as described above for the preceding embodiments. The valve device 3 includes a thread portion 3b, which has external threads 3a (for threaded engagement with the internal threads 2a of the mouth portion 2) formed on an outer peripheral surface thereof, and contains a shut-off valve (such as a solenoid valve or a pressure regulating valve) therein, a projection 3c, which projects further into the inside of the tank than the thread portion 3b, and has an introduction passage for introducing gas within the tank into the valve device 3, and a gas discharging portion 3d which is disposed outwardly of the thread portion 3b, and is larger in diameter than the thread portion 3b. Further, a seal member-fitting groove 3h, corresponding to the sealing surface 2g, is formed in the valve device 3 inwardly of the thread portion 3b. Therefore, a seal member 6, provided in the seal member-fitting groove 3h, is disposed adjacent to the inner end of the mouth portion 2.

In the above structure, the seal member 6 is fitted in the seal member-fitting groove 3h in the valve device 3, and then the valve device 3 is attached to the mouth portion 2 of the tank 1 by threadedly engaging the external threads 3a with the internal threads 2a formed on the mouth portion 2, as shown in FIG. 4. As a result, the seal member 6 is held in close contact with the sealing surface 2g of the mouth portion 2, thereby preventing the gas within the tank 1 from leaking to the exterior.

The seal member 6 is provided at the inner end of the mouth portion 2, that is, disposed inwardly of the region where the internal threads 2a and external threads 3a are threadedly engaged with each other. With this construction, the atmospheric pressure acts on the outer peripheral surface and inner peripheral surface (serving as the threaded portion) of the mouth portion 2 as indicated by arrows A in FIG. 4. Therefore, the same pressure acts on the inner and outer peripheral surfaces of the mouth portion 2, and the pressures therebetween are balanced, so that the mouth portion 2 will not be deformed by the pressure. Therefore, the loosening of the tightened seal member 6 is prevented, and the sealing ability and pressure-proof strength at the mouth portion 2 are enhanced, and the durability of the tank is enhanced.

In this fourth embodiment, also, the internal structure of the valve device 3 is similar to that of the first embodiment, and the gas within the tank 1 can be discharged by the valve device 3.

In the above embodiments, although the valve device is used as the thread member 3, any other suitable thread member, such as a plug and a cock, may be used.

With the above constructions according to the present invention, the sealing ability and pressure-proof strength at the mouth portion are prevented from being lowered by the high pressure within the tank, thereby enhancing the durability of the tank.

What is claimed is:

1. A high-pressure tank including a mouth portion having internal threads formed on an inner peripheral surface thereof, wherein said mouth portion is so provided that a pressure within said tank acts on an outer peripheral surface of said mouth portion.

2. A high-pressure tank including a mouth portion having internal threads formed on an inner peripheral surface thereof, wherein said mouth portion projects into the inside of said high-pressure tank so that a pressure within said tank acts on an outer peripheral surface of said mouth portion.

3. A high-pressure tank including a mouth portion having internal threads formed on an inner peripheral surface thereof, wherein said mouth portion projects into the inside of said high-pressure tank so that a pressure within said tank acts on an outer peripheral surface of said mouth portion; and a seal member is provided on the inner peripheral surface of said mouth portion adjacent to an inner end of said mouth portion.

4. A high-pressure tank according to claim 1, in which said high-pressure tank includes an outer wall, projecting outwardly from an outer surface of said tank, and an inner wall extending from an outer end of said outer wall into the inside of said tank, and said mouth portion being defined by said inner wall.

5. A high-pressure tank according to claim 2, in which said high-pressure tank includes an outer wall, projecting outwardly from an outer surface of said tank, and an inner wall extending from an outer end of said outer wall into the inside of said tank, and said mouth portion being defined by said inner wall.

6. A high-pressure tank according to claim 3, in which said high-pressure tank includes an outer wall, projecting outwardly from an outer surface of said tank, and an inner wall extending from an outer end of said outer wall into the inside of said tank, and said mouth portion being defined by said inner wall.

7. A high-pressure tank according to claim 1, in which a valve device is threadedly engaged with said internal threads of said mouth portion.

8. A high-pressure tank according to claim 2, in which a valve device is threadedly engaged with said internal threads of said mouth portion.

9. A high-pressure tank according to claim 3, in which a valve device is threadedly engaged with said internal threads of said mouth portion.

10. A high-pressure tank according to claim 4, in which a valve device is threadedly engaged with said internal threads of said mouth portion.

11. A high-pressure tank according to claim 5, in which a valve device is threadedly engaged with said internal threads of said mouth portion.

12. A high-pressure tank according to claim 6, in which a valve device is threadedly engaged with said internal threads of said mouth portion.

13. A high-pressure tank including a mouth portion having internal threads formed on an inner peripheral surface thereof, wherein said mouth portion is so provided that pressures, acting respectively on inner and outer peripheral surfaces of said mouth portion, are substantially equal to each other.

14. A high-pressure tank according to claim 13, in which said mouth portion projects into the inside of said high-pressure tank, and a seal member is provided on the inner peripheral surface of said mouth portion adjacent to an outer end of said mouth portion.

15. A high-pressure tank according to claim 13, in which said mouth portion projects outwardly from an outer surface of said high-pressure tank, and a seal member is provided on the inner peripheral surface of said mouth portion adjacent to an inner end of said mouth portion.

16. A high-pressure tank according to claim 13, in which a valve device is threadedly engaged with said internal threads of said mouth portion.

17. A high-pressure tank according to claim 14, in which a valve device is threadedly engaged with said internal threads of said mouth portion.

18. A high-pressure tank according to claim 15, in which a valve device is threadedly engaged with said internal threads of said mouth portion.
